(19) United States
(12) Patent Application Publication
(10) Pub. No.: US 2013/0300188 A1
(43) Pub. Date: Nov. 14, 2013

(54) PARTIALLY ADHERED FLEXIBLE AXLE FOR A MOTOR VEHICLE

(71) Applicants: Sebastien Dhont, La Bazoge (FR); Emmanuel Dube, Laigne En Belin (FR); Alain Patigniez, Sainte Jamme Sur Sarthe (FR)

(72) Inventors: Sebastien Dhont, La Bazoge (FR); Emmanuel Dube, Laigne En Belin (FR); Alain Patigniez, Sainte Jamme Sur Sarthe (FR)

(73) Assignee: RENAULT s.a.s, Boulogne-Billancourt (FR)

(21) Appl. No.: 13/883,581

(22) PCT Filed: Nov. 4, 2011
(86) PCT No.: PCT/EP2011/069470

§ 371 Date: Jul. 2, 2013

(30) Foreign Application Priority Data
Nov. 5, 2010 (FR) 1059171

(51) Int. Cl. B60B 35/00; B62D 65/12

(52) U.S. Cl. CPC B60B 35/004; B62D 65/12
USPC 301/124.1; 29/458

(57) ABSTRACT

A flexible axle including at least one first arm to connect a vehicle body to a wheel support, and a crossbeam including at least one first end that can be adhered to the first arm, wherein an arm that can be assembled by adhesion includes plural portions which, when joined together in a first transverse direction relative to the longitudinal axis of the crossbeam, define a recess having a shape essentially complementary to that of the first end of the crossbeam that the recess receives.

The present invention relates to a flexible axle for a motor vehicle.

An axle that is “flexible” means an axle that is designed to form a torsion element between two wheels of the same axle set of the motor vehicle.

Such a flexible axle is generally made up of two longitudinal arms joined together by a crossmember. The arms connect the bodyshell to the wheel supports and also bear suspension elements, bump stops and serve for the attachment of the shock absorbers. The crossmember provides the axle with flexural stiffness (toe in/out and camber) and torsional stiffness (antiroll function).

Flexible axles have high flexural stiffness and relative torsional flexibility because of a generally V-shaped or U-shaped section created from a tubular shape.

Traditionally, bonded axles have been assembled by pushing the ends of the crossmember into housings machined beforehand in the arms, the assembly thus created often being reinforced by welding.

However, the quality of the bonding is not well controlled, essentially because of the push-fit assembly process. Assembly is therefore often imperfect and complicated to achieve on the assembly line. This is because the constraints to be taken into consideration in the case of a bonded assembly are as follows:
A bonded assembly between the crossmember and the arms means complying with a very tight assembly tolerance. The adhesive manufacturers demand adhesively-bonded joint thicknesses of between 0.3 mm and 0.7 mm.
Because the shapes of the crossmember are achieved from forming and heat treatment operations, there is a great deal of spread on these shapes. In the case of ends that are oblong, rather than cylindrical, this spread is accentuated by the addition of the defect of twist between the two ends of the crossmember.
Forming ends that are oblong is a more complex matter than keeping ends that are cylindrical and leads to even greater spread on shape.

A conventional design would be to insert the crossmember into oblong housings created in the arms. So doing, when the dimensional spread on the ends of the crossmember is taken into consideration when defining the machining of the housings in the arms, results in high risks of obtaining adhesively-bonded joint thicknesses which are very much greater than the manufacturer recommendations (of the order of 1.5 mm).

In addition, because each end of the crossmember is moved axially in order to enter the housing in the corresponding arm, shape defects and the tight adhesive-bonding clearances mean that the adhesive is scraped during assembly. The result of that is that the end-product is not robust. There are significant risks that there will be zones that have not been bonded, in some cases, the adhesive having been pushed down to the bottom of the housing.

As it stands, the use of a crossmember with oblong ends, each one bonded to an arm, the “female” oblong housing for which is created, for example, by machining, does not yield a bonded assembly that is sufficiently robust: there is a risk that there will be too great a thickness of adhesive for the load that is to be transmitted, or the converse, or even lacks of adhesive caused by scraping during assembly.

The objective is to develop an axle that is capable not only of meeting the traditional set of specifications but also which can be assembled in a way that avoids all or some of the above disadvantages.

American patent U.S. Pat. No. 5,800,024 is known, for example, and relates to a flexible axle for a rear axle set of a motor vehicle, notably comprising an aluminum crossmember mounted on control arms. According to one of the embodiments, the cylindrical crossmember is attached by adhesive bonding into a complementary shape in the arm using an intermediate component.

German patent DE 195 42 523 is also known and discloses a connection between arms and a crossmember. The arms have a blind housing able to accommodate cylindrical sleeves welded to the crossmember, the sleeves being first of all bonded into the housings in the arms. This form of connection using bonding and welding increases the production cost.

Also known is German patent DE 197 52 347 which relates to a bonded assembly between a crossmember and lateral elements at each end of the crossmember. There is an opening through which adhesive is introduced. Moreover, a mechanical connection is added to the bonded assembly, using screws or rivets.

Finally, European patent EP 1 036 680 is known and describes an axle for a motor vehicle, comprising two arms, each having a housing accommodating one of the two ends of a crossmember, the crossmember and the arms being assembled by adhesive bonding. Part of the invention relates to the creation of annular slots between the ends of the crossmember and the housings, these slots being filled with adhesive. One of the embodiments shows a later mechanical deformation of the bonded zone so as to enhance the mechanical strength.

Therefore none of these documents discloses an axle the design of which is able to alleviate the abovementioned disadvantages.

Therefore the proposal is a flexible axle comprising:
at least one first arm, designed to connect the bodyshell to a wheel support,
a crossmember having at least one first end, able to be bonded to the first arm,

said arm, able to be assembled by bonding, having several parts which, joined together in a first direction transverse to the longitudinal axis of the crossmember, define a housing of a shape that essentially complements that of said first end of the crossmember that it houses. A direction that is “transverse” means a direction that intersects the longitudinal axis of the crossmember, not necessarily orthogonally.

According to the invention, the crossmember is able to be placed in the housings that have already had adhesive applied to them. This then limits the risk of scraping the adhesive which generally occurs when the crossmember is pushed in, and the quality of the adhesive bonding is better controlled. A visual inspection is also possible.

The adhesive is then distributed more evenly over all the contact surfaces for contact between the various parts of the arm that define the housing and the crossmember, making the assembly more robust.

According to one advantageous embodiment, the first end of the crossmember has a shape without undercut. For preference, the shape of the first end of the crossmember is substantially oblong, making connection easier while encouraging good distribution of load.

According to one advantageous embodiment, the parts of said first arm which define the housing are fixed together by clamping elements, which are preferably screws. Furthermore, the parts of said first arm which define the housing, and even the screws, can be fixed to the crossmember by adhesive bonding.

The assembly is thus secured, encouraging adhesive bonding via better-guaranteed contact. Any shape defects there might be, affecting the crossmember and the housings, and the small adhesive-bonding clearances, are then compensated for when the various parts that define the housings are clamped (or screwed) together, at the same time complying with the manufacturer recommendations regarding the thicknesses of adhesive.

Advantageously, at least the first end of the crossmember is bonded to at least part of the first arm of the axle.

According to one advantageous embodiment, the first arm has two cradle-like parts forming the housing for the first end of the crossmember.

For preference, the crossmember has two identical ends, and the second end of the crossmember is connected to a second arm in the same way as the first end of the crossmember is connected to the first arm.

According to one advantageous embodiment, the crossmember, with the exception of its ends, has a substantially V-shaped generatrix section, thereby enhancing the rigidity of the crossmember.

Also covered here is a method of assembling an axle comprising:
a crossmember having at least one first end,
at least one first arm having several parts which, joined together in a first direction transverse to the longitudinal axis of the crossmember, define a housing the shape of which essentially complements that of the first end of the crossmember that it houses,

said method comprising:
a positioning step during which a first part of said first arm defining the housing is positioned and held in position;
an adhesive application step during which the surface of said first part of said positioned first arm that is intended to make contact with said first end of the crossmember is coated with adhesive;
a step during which said first end of the crossmember is positioned on contact with said adhesive-coated first part of said first arm;
another adhesive application step during which the surface of the other parts of said first arm which define the housing for said first end of the crossmember is coated with adhesive;
an assembly step during which the parts of said first arm which define the housing are positioned together;
a clamping step during which the various parts of said first arm which define the housing are clamped against said first end of the crossmember.

The assembly machinery is simplified and less expensive because, according to a preferred embodiment, it is then possible for the two ends of the crossmember to be positioned and adhesively bonded at the same time and there is no need to have a system for laterally push-fitting the crossmember into the first arm and a system for push-fitting the second arm onto the crossmember.

Advantageously, at least the first end of the crossmember is also coated with adhesive prior to the assembly step.

According to one advantageous assembly mode, the first end of the crossmember is placed resting against the first part of the housing. Indeed, it is advantageous for the first end of the crossmember to be rested in the first part of the housing so that the crossmember and the first part of the housing do not have to be held in position separately in order to bring them into contact.

Furthermore, because the arms are held rigidly and in position in the assembly setup, the resulting axle geometry is improved.

For preference, the various parts of said first arm which define the housing are clamped against the first end of the crossmember using screws.

According to another advantageous assembly mode, a second end of the crossmember is assembled with a second arm in the same way.

For preference, the first end of the crossmember is assembled according to the process described above at the same time as a second end of the crossmember.

Finally, a motor vehicle comprising a flexible axle as described hereinabove is also covered here.

The invention, according to a preferred embodiment, will be clearly understood and its advantages will become better apparent from reading the following entirely indicative and nonlimiting detailed description and by referring to the attached drawings which are as follows:

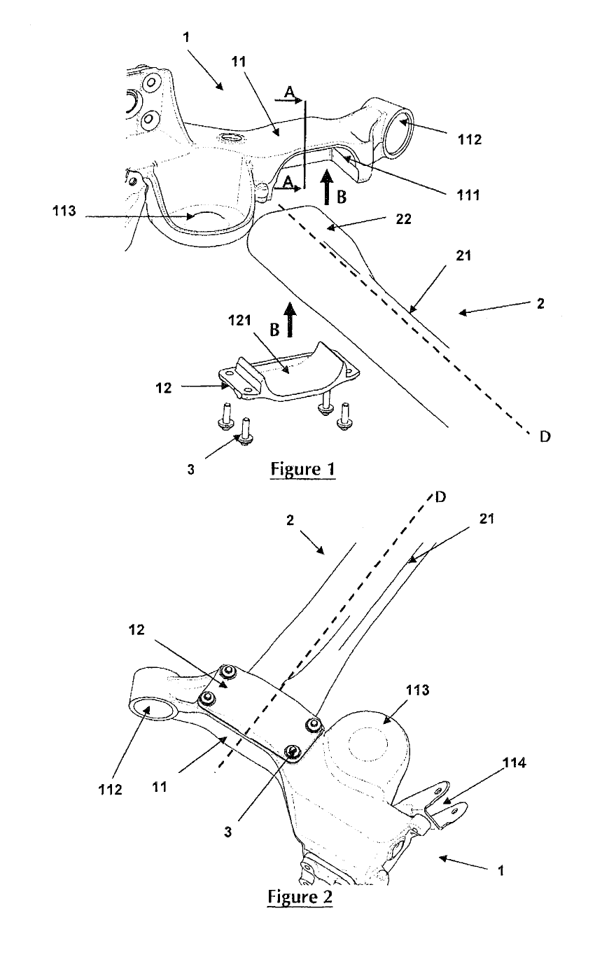

FIG. 1 shows an exploded view of the assembly,

FIG. 2 depicts the set of elements that make up the axle once they have been assembled.

Identical elements depicted in FIGS. 1 and 2 are identified by identical numerical references.

The axle depicted in part is made up of:
an arm 1, able to connect the bodyshell to the wheel supports,
a crossmember 2 able to be fixed to the arm 1.

For preference, the arm 1 is an aluminum casting. The arm 1 may, for example, be obtained by molding.

For preference, the crossmember 2 is made of steel or of composite. It may be obtained by extrusion and pressing. Depending on the stress loadings it is to bear, it may also be heat treated or shot peened.

Thus, the materials and forming methods chosen make it possible to ensure that the axle will meet the traditional set of specifications.

In this particular instance, the crossmember 2 is essentially formed of a cylinder 21 that is pressed to give a substantially V-shaped generatrix section as known in the field.

For preference, the end 22 of the crossmember 2 has a shape without undercut so as to avoid, for example, differing thicknesses of adhesive in the assembly zone, as this could weaken the bond. In this particular instance, the end 22 is of oblong shape, this notably making connection easier while at the same time encouraging good distribution of load.

The arm 1 has several parts (11, 12) which, joined together in a first direction B transverse to the longitudinal axis D of the crossmember 2, define a housing the shape of which essentially complements that of the end 22 of the crossmember 2 that it houses.

According to the preferred embodiment depicted, the arm 1 of the axle is made up of two parts:
a body 11 comprising a first part of the housing 111,
a cover 12 comprising a second part of the housing 121.

The body 11 is the largest part of the arm which constitutes the housing. Aside from the part 111 of the crossmember housing, the body 11 comprises elements for connection to other functional elements, such as a bearer 113 for the suspension springs and the bump stops, a connection 112 between the axle and the chassis, and a shock absorber fixing 114, for example.

According to the present embodiment, the first part of the housing 111 represents substantially half of the complete housing, and the second part of the housing 121, formed by the cover 12, represents the other half.

The direction of the assembly may, however, be different. For example, the arm 1 may be split vertically at the crossmember 2, i.e. for example along the axis A-A.

This is because the fact that the various parts of the arm 1 defining the housing (111, 121) are assembled along a plane of symmetry of the housing makes mating it with the end 22 of the crossmember 2 easier.

The various parts (111, 121) of the housing into which parts the end 22 of the crossmember 2 is positioned are, for example, machined in the arm. They may also be molded into the components.

The various parts (11, 12) of the arm 1 that define the housing (111, 121), and the crossmember 2, are assembled by adhesive bonding.

In order to assemble an axle as depicted, either the surface of the housing 111 or the periphery of the end 22 of the crossmember 2, or both, need therefore to be coated with adhesive and then the end 22 of the crossmember 2 needs to be positioned in the housing 111 of the body 11 of the arm 1, the body 1 preferably being positioned under the end of the crossmember, as shown in FIG. 2. Such an arrangement is advantageous because the end 22 of the crossmember 2 can then be rested in the housing 111.

Furthermore, this arrangement allows the first end (22) of the crossmember (2) to be assembled at the same time as a second end of the crossmember (2) and using the same mode of assembly.

Next, the remainder of the surface of the end 22 of the crossmember 2 and/or the surface of the housing 121 of the cover 12 is coated with adhesive and the cover is positioned in such a way that it closes the housing (111, 121).

This method makes it easier to comply with the manufacturer recommendations regarding the thicknesses of adhesive to be applied.

Once assembled, the various parts of the arm 1 are fixed together by clamping elements.

In this particular instance, screws 3 are added to clamp the assembly and encourage the transmission of load between the front and rear parts of the body 11 of the arm 1 and to apply pressure in the bonded assembly between the various parts of the housing (111, 112) and the end 22 of the crossmember 2.

If the bonded assembly is not subject to high stress loadings during operation, then the screws 3 may be omitted. Nonetheless, at the time of bonding of the various parts of the arm 1 that define the housing, it is necessary to apply pressure in order to ensure bonding.

Moreover, certain parts of the arm defining the housing may have strengtheners. For example, the cover 12 may have strengtheners on its external face. This is because the clamping of the various parts defining the housing at the time of adhesive bonding gives rise to deformations, and therefore to stresses, which are added to the stresses caused by operational use of the axle.

The invention also makes it possible, in addition to affording advantages regarding the quality and reliability of the bonded connection between the crossmember and the arm, as has just been mentioned, to simplify the assembly device because the two sides of the crossmember are bonded at the same time. In addition, the bonding method avoids the use of systems for laterally push-fitting the crossmember into the first arm and an equivalent system for push-fitting the second arm into the other end of the crossmember.

Moreover, because the arms are held rigidly and in position in the assembly setup, the resulting geometry of the bonded axle is improved.

Naturally, various alternative forms are possible without thereby departing from the scope of the invention. For example, the same problem may arise in the case of other constituent parts of a motor vehicle comprising a crossmember and two lateral elements, to which an analogous solution may be applied.

1-13. (canceled)

14. A flexible axle comprising:
at least one first arm, configured to connect a bodyshell to a wheel support;
a crossmember including at least one first end;
the arm including plural parts which, joined together in a first direction transverse to the longitudinal axis of the crossmember, define a housing of a shape that essentially complements that of the first end of the crossmember that it houses;
wherein the first end of the crossmember is bonded to at least part of the first arm.

15. The flexible axle as claimed in claim 14, wherein the first end of the crossmember has a shape without undercut.

16. The flexible axle as claimed in claim 14, wherein the shape of the first end of the crossmember is substantially oblong.

17. The flexible axle as claimed in claim 14, wherein the plural parts of the first arm which define the housing are fixed together by clamping elements.

18. The flexible axle as claimed in claim 14, wherein the plural parts of the first arm which define the housing are fixed together by screws.

19. The flexible axle as claimed in claim 14, wherein the first arm includes two cradle-like parts forming the housing for the first end of the crossmember.

20. The flexible axle as claimed in claim 14, wherein the crossmember, with exception of its ends, has a substantially V-shaped generatrix section.

21. A method of assembling an axle including: a crossmember including at least one first end; and at least one first arm including plural parts which, joined together in a first direction transverse to the longitudinal axis of the crossmember, define a housing a shape of which essentially complements that of the first end of the crossmember that it houses; the method comprising:
a first positioning during which a first part of the first arm defining the housing is positioned and held in position;
a first adhesive application during which a surface of the first part of the positioned first arm intended to make contact with the first end of the crossmember is coated with adhesive;
a second positioning the first end of the crossmember on contact with the adhesive-coated first part of the first arm;
a second adhesive application during which the surface of other parts of the first arm which define the housing for the first end of the crossmember is coated with adhesive;
an assembly during which the plural parts of the first arm which define the housing are positioned together;
a clamping during which the plural parts of the first arm which define the housing are clamped against the first end of the crossmember.

22. The method of assembly as claimed in claim 21, wherein the first end of the crossmember is also coated with adhesive prior to assembly.

23. The method of assembly as claimed in claim 21, wherein the first end of the crossmember is placed resting against the first part of the housing.

24. The method of assembly as claimed in claim 21, wherein the plural parts of the first arm which define the housing are clamped against the first end of the crossmember using screws.

25. The method of assembly as claimed in claim 21, wherein the first end of the crossmember is assembled at a same time as a second end of the crossmember.

26. A motor vehicle, comprising a flexible axle as claimed in claim 14.
